(19) United States
(12) Patent Application Publication
(10) Pub. No.: US 2016/0018003 A1
(43) Pub. Date: Jan. 21, 2016

(54) V-RING SEAL WITH SHIELDS

(71) Applicant: Yefim Epshetsky, Schaumburg, IL (US)

(72) Inventor: Yefim Epshetsky, Schaumburg, IL (US)

(73) Assignee: AKTIEBOLAGET SKF, Goteborg (SE)

(21) Appl. No.: 14/333,880

(22) Filed: Jul. 17, 2014

(51) Int. Cl. F16J 15/32

(52) U.S. Cl. CPC F16J 15/322

(57) ABSTRACT

A seal assembly is for sealing a space between first and second members, the first member having a central axis and an outer circumferential surface extending about the axis, the second member having a radially-extending axial surface, the first member being rotatable about the central axis. A generally annular elastomeric seal body is disposed about the first member outer surface and extends circumferentially about the central axis, the body including a base portion and a sealing portion, the sealing portion having an inner end integrally formed with the base portion and an outer, free end sealingly engageable with the second member axial surface so as to define a generally annular seal interface. At least one shield is coupled with the second member and spaced radially-outwardly from and located generally vertically above the seal interface so as to provide a barrier for preventing entry of substances into the seal interface.

### BACKGROUND OF THE INVENTION

The present invention relates to seals, and more particularly to V-ring seals for sealing against axial surfaces.

V-ring axial seals are known and typically include an annular elastomeric body having a main body portion and a cantilever-like sealing portion extending from the main body portion. The seal body is disposed on a shaft or other mechanical member and the sealing portion engages with an axial surface of another, adjacent mechanical member so as to seal an axial space between the shaft/member and the other member.

Although such seals are generally effective, the integrity of the seal between the sealing portion and the axial surface can be affected when dust or other debris enters the interface between the sealing portion and surface. That is, dust or debris may become disposed between the seal body sealing portion and the axial surface, which if accumulating in sufficient quantity, can create an opening for liquids or other substances to pass therethrough.

### SUMMARY OF THE INVENTION

In one aspect, the present invention is a seal assembly for sealing a space between first and second members, the first member having a central axis and an outer circumferential surface extending about the axis, the second member having a radially-extending axial surface, one of the first and second members being rotatable about the central axis. The seal assembly comprises a generally annular elastomeric seal body disposed about the first member outer surface and extending circumferentially about the central axis. The body includes a base portion and a sealing portion, the sealing portion having an inner end integrally formed with the base portion and an outer, free end sealingly engageable with the second member axial surface so as to define a generally annular seal interface. At least one shield is coupled with a non-rotatable one of the first and second members and is spaced radially-outwardly from, and located generally vertically above, the seal interface. As such, the shield provides a barrier for preventing entry of substances into the seal interface.

In another aspect, the present invention is again a seal assembly for sealing a space between first and second members, the first member having a central axis and an outer circumferential surface extending about the axis, the second member having a radially-extending axial surface, the first member being rotatable about the central axis. The seal assembly comprises a generally annular elastomeric seal body disposed about the first member outer surface and extending circumferentially about the central axis. The body includes a base portion and a sealing portion, the sealing portion having an inner end integrally formed with the base portion and an outer, free end sealingly engageable with the second member axial surface so as to define a generally annular seal interface. At least one shield is coupled with the second member and is spaced radially-outwardly from and located generally vertically above the seal interface so as to provide a barrier for preventing entry of substances into the seal interface.

In a further aspect, the present invention is once again a seal assembly for sealing a space between first and second members, the first member having a central axis and an outer circumferential surface extending about the axis, the second member having a radially-extending axial surface, one of the first and second members being rotatable about the central axis. The seal assembly comprises a generally annular elastomeric seal body disposed about the first member outer surface and extending circumferentially about the central axis. The body includes a base portion and a sealing portion, the sealing portion having an inner end integrally formed with the base portion and an outer, free end sealingly engageable with the second member axial surface so as to define a generally annular seal interface. A first shield is coupled with the second member and is spaced radially-outwardly from and located generally vertically above a first portion of the seal interface so as to provide a barrier for preventing entry of substances into the seal interface first portion. Further, a second shield is coupled with the second member, spaced circumferentially about the axis from the first shield, and spaced radially-outwardly from and located generally vertically above a second portion of the seal interface so as to provide a barrier for preventing entry of substances into the seal interface second portion.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of a machine assembly having a seal assembly with shields in accordance with the present invention;

FIG. 2 is a broken-away, enlarged view of an upper portion of FIG. 1, showing a first shield construction;

FIG. 3 is a view through line 3-3 of FIG. 1, showing two shields of the first construction;

FIG. 4 is an enlarged view of a portion of FIG. 3;

FIG. 5 is an axial cross-sectional view of the seal assembly, showing a second shield construction; and

FIG. 6 is a view similar to FIG. 3, but depicting three shields of the second construction.

### DETAILED DESCRIPTION OF THE INVENTION

Certain terminology is used in the following description for convenience only and is not limiting. The words “above”, “upper”, “upward”, “down” and “downward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

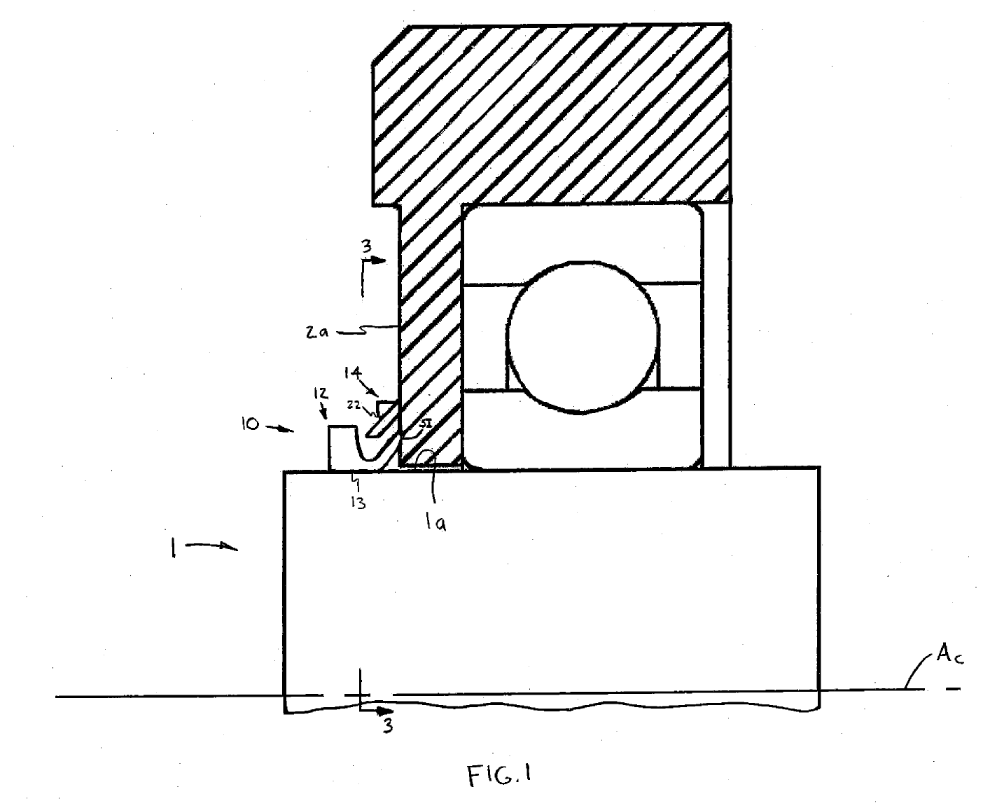

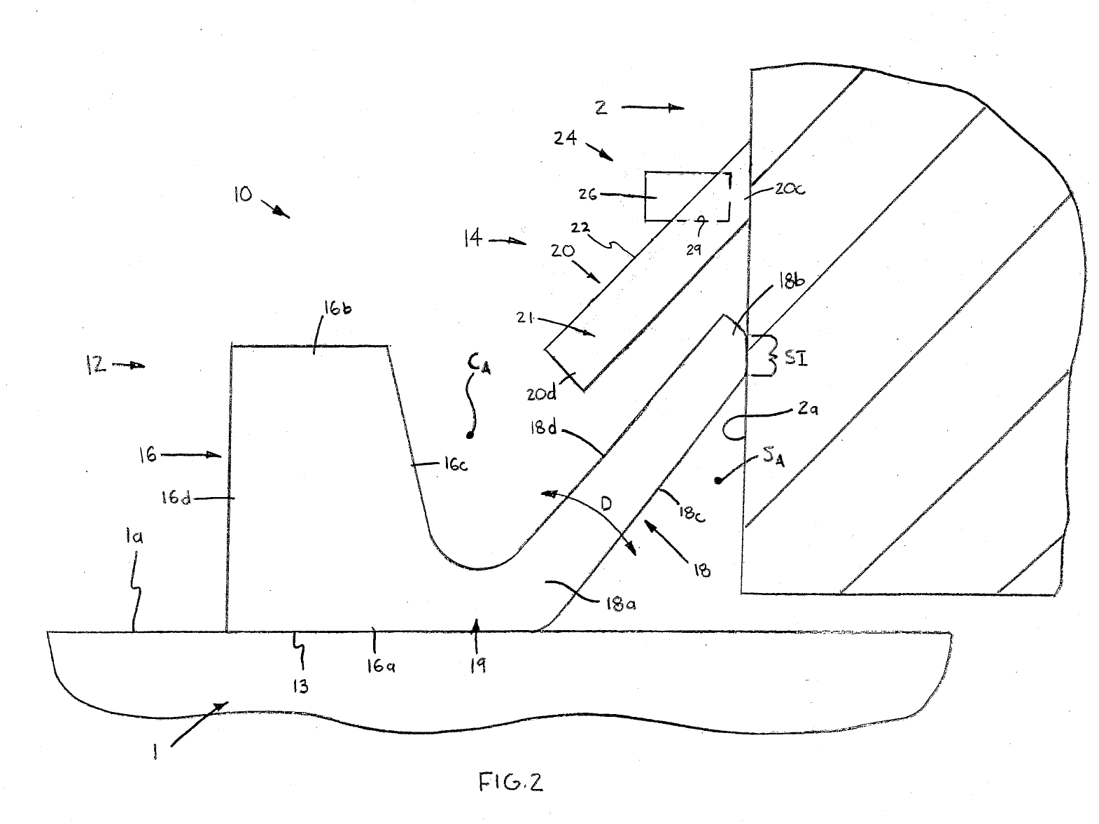

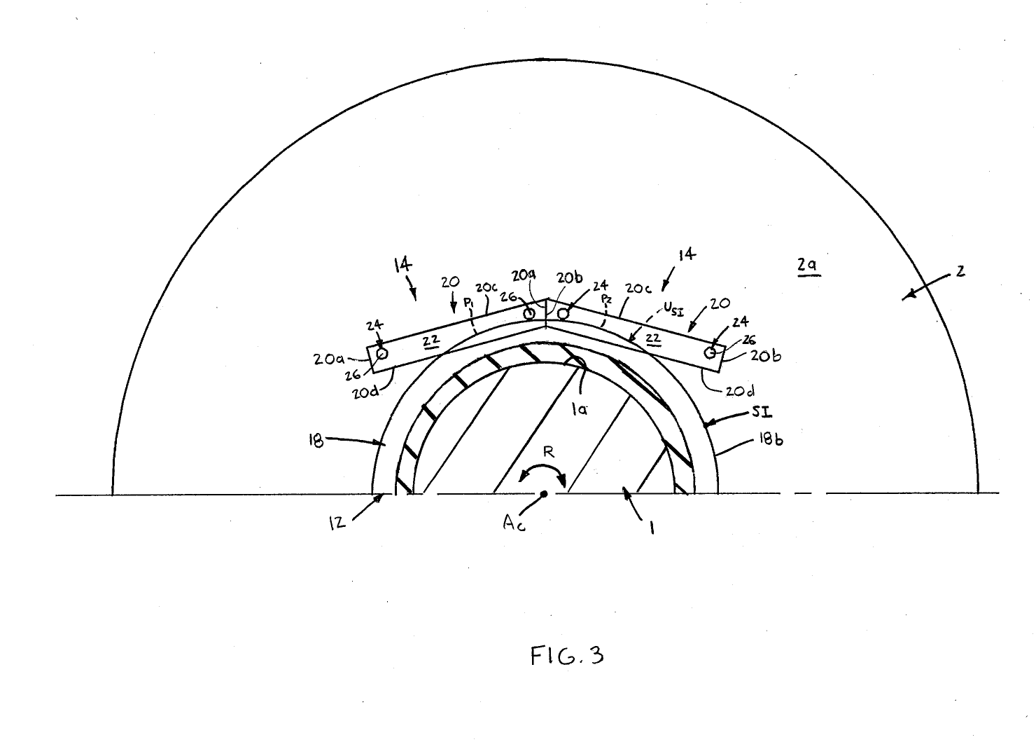

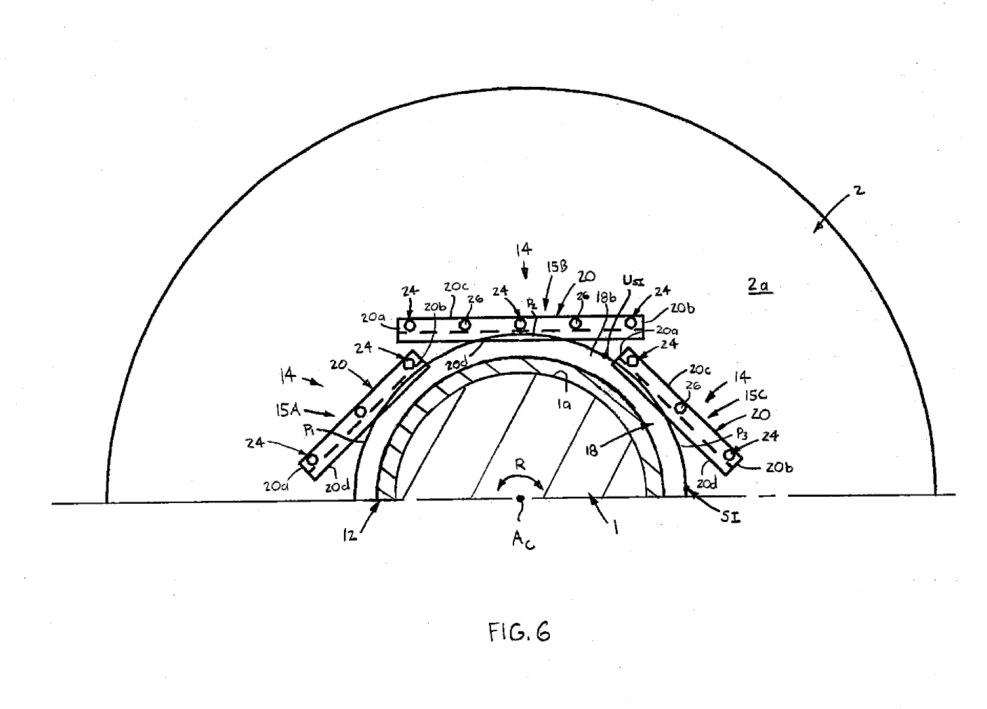

Referring now to the drawings in detail, wherein like numbers are used to indicate like elements throughout, there is shown in FIGS. 1-6 a seal assembly 10 for sealing a space S_{A} between first and second members 1, 2, respectively. The first member 1 has a central axis A_{C} and an outer circumferential surface 1a extending about the axis A_{C} and the second member 2 has a radially-extending axial surface 2a. One of the first and second members 1, 2, preferably the first member 1, is rotatable about the central axis A_{C}, as indicated by arrow R in FIGS. 3 and 6. The seal assembly 10 basically comprises a generally elastomeric seal body 12 and at least one, and preferably at least two, shields 14. The seal body 12 is disposed about the first member outer surface 1 a and extends circumferentially about the central axis A_{C}, the body 12 including a base portion 16 and a sealing portion 18. The sealing portion 18 has an inner end 18a integrally formed with the base portion 16 and an outer, free end 18b sealingly engageable with the second member axial surface 2a so as to define a generally annular seal interface SI. Further, a generally annular cavity C_{A} is defined between the base portion 16 and the sealing portion 18, and the body 12 preferably further includes an integral hinge portion 19 connecting the sealing portion 18 with the base portion 16. As such, the sealing portion 18 is deflectable about the hinge portion 19 in generally axial directions with respect to the base portion 16, as indicated by arrow D in FIG. 2.

Furthermore, the at least one shield 14 is coupled with the non-rotatable one of the first and second members 1, 2 and is spaced radially-outwardly from, and located generally vertically above, the seal interface SI. As such, the one or more shields 14 provide a barrier for preventing entry of substances into the seal interface SI. As mentioned above, the first member 1 is preferably rotatable and the second member 2 is non-rotatable. In this preferred arrangement, the at least one shield 14 is mounted on the second member 2 and arranged to extend axially toward the first member 1 so as to overhang an upper section u_{SI} of the seal interface SI. Preferably, the one or more shields 14 are each attached to the second member axial surface 2a, as depicted in the drawings, but may alternatively be attached to any other portion of the second member 2 or even a third member proximal to the first and second members 1, 2.

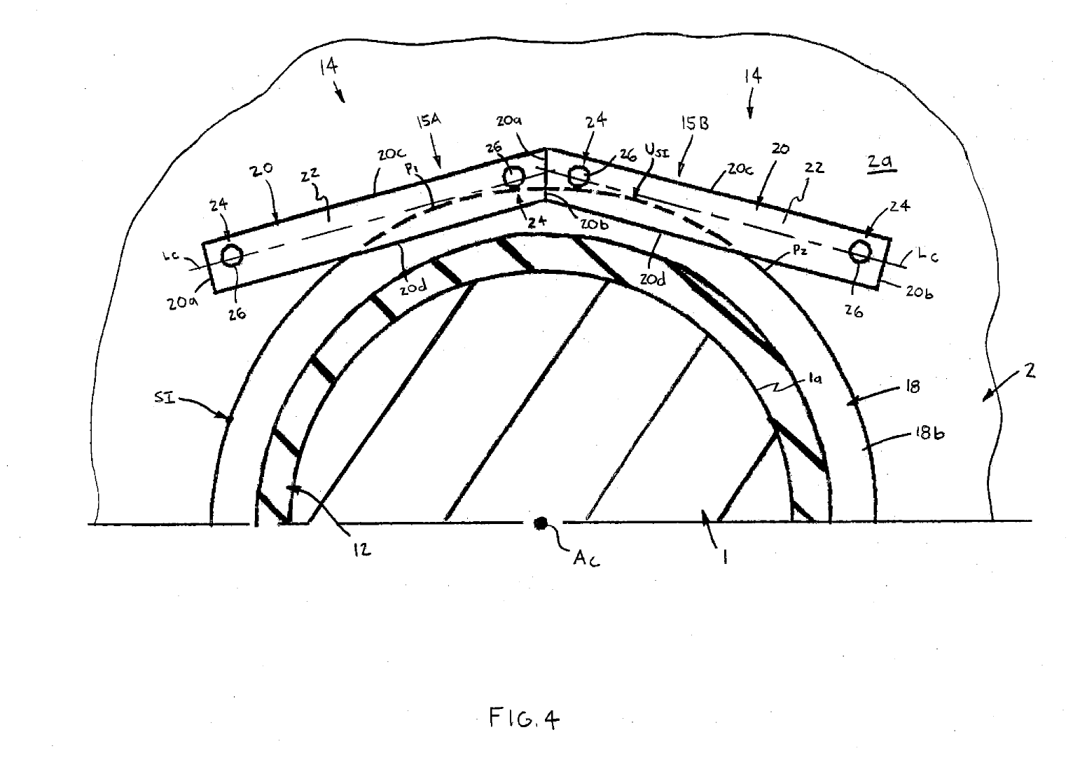

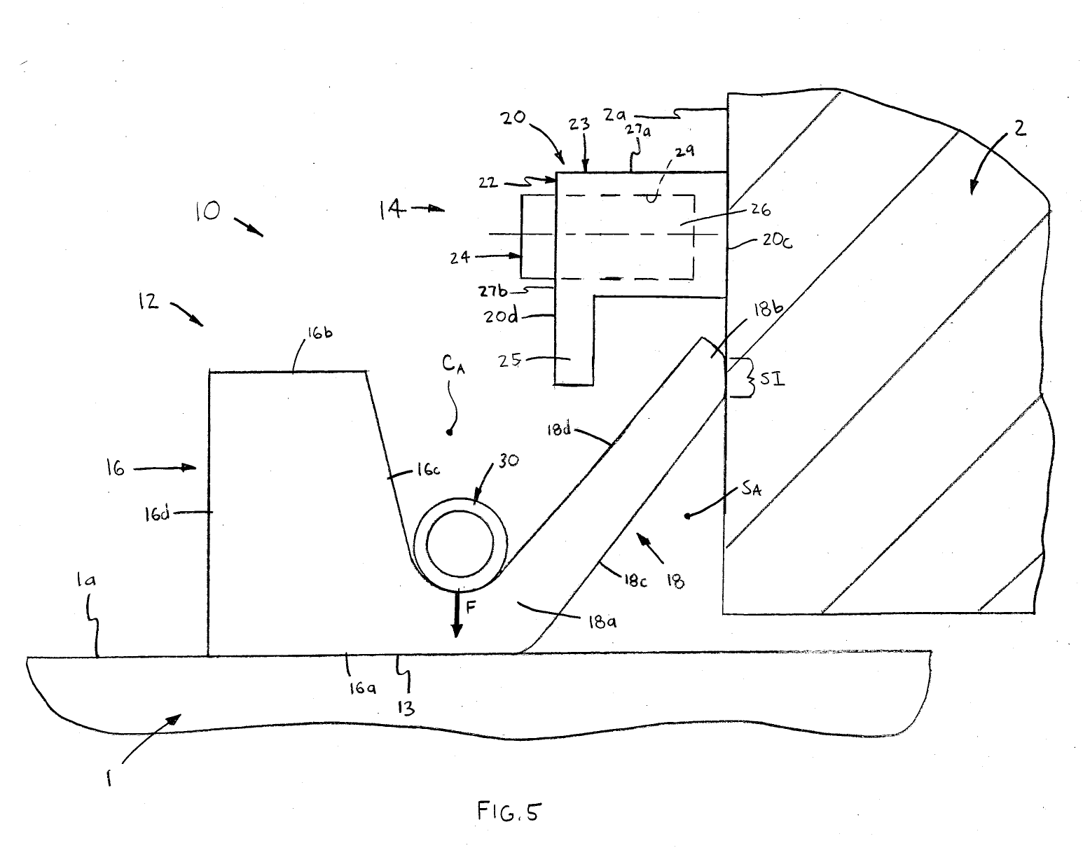

Referring to FIGS. 2-6, each shield 14 preferably includes an elongated body 20 providing an upper barrier surface 22 and at least one and preferably a plurality of connectors 24 for coupling the body 20 to the second member 2. Each shield body 20 has two opposing circumferential ends 20a, 20b, a centerline L_{C} (FIG. 4) extending generally between the circumferential ends 20a, 20b, and two opposing axial ends 20c, 20d. The barrier surface 22 faces generally away from the central axis A_{C} and extends both generally axially between the axial ends 20c, 20d and generally transversely or circumferentially between the circumferential ends 20a, 20b. Preferably, each shield body 20 is formed as either a generally straight, generally rectangular plate (FIGS. 2-4) or as a generally rectangular block (FIGS. 5 and 6), as discussed in greater detail below. However, each shield body 20 may be formed of any other appropriate shape, such as generally arcuate or curved, and/or the body 20 may be formed of an assembly of multiple pieces. Further, each connector 24 preferably includes a magnet 26, such that the connector 24 is configured to releasably attach the shield 14 to the second member axial surface 2a, the shield 14 thereby being readily positioned and retained at any desired location on the second member axial surface 2a. Alternatively, the one or more connectors 24 may each be formed in any other appropriate manner, such as a threaded fastener, a clamp, etc., or the body 20 may be directly attached to the second member 2 by means of an adhesive, weldment, etc.

As best shown in FIGS. 3, 4 and 6, each shield body 20 is positioned on the non-rotatable member 1 or 2 such that the body centerline L_{C} extends generally perpendicularly with respect to the central axis A_{C}. As such, each shield 14 extends generally along the circumference or perimeter of the sealing interface SI, and thus also of the outer end 18b of the seal body sealing portion 18. Also, one axial end 20c of the body 20 is coupled with the non-rotatable member 1 or 2 and the other axial end 20d is located such that the upper section u_{SI} of the seal interface SI is generally covered by the barrier surface 22. That is, the outer end 18b of the sealing portion 18 is disposed generally between the shield body axial ends 20c, 20d so that the barrier surface 22 extends generally axially across the seal interface SI.

Referring to FIGS. 2 and 5, the annular elastomeric seal body 12 is preferably formed as a conventional “V-ring” seal. As such, the elastomeric body 12 has generally V-shaped axial cross-sections, i.e., cross-sections taken along the axis A_{C}. More specifically, the base portion 16 has a generally rectangular cross-sectional shape and the sealing portion 18 is preferably generally cantilever-like in cross-section, with the joint portion 19 extending generally axially between the two sections 16, 18. Further, the body base portion 16 has inner and outer radial ends 16a, 16b and opposing inner and outer axial ends 16c, 16d, and the body sealing portion 18 has inner and outer angled surfaces 18c, 18d, which each extend both generally radially and generally circumferentially. Thus, the annular cavity C_{A} is substantially bounded or defined by the base portion inner axial end 16c and the sealing portion outwardly-facing angled surface 18c. Furthermore, the inner end 18a of the body sealing portion 18 is integrally formed with the base inner axial end 16c at a position proximal to the base inner radial end 16a, most preferably being coupled by the integral hinge section 19. As such, the sealing portion 18 extends from the sealing portion inner end 18a to the sealing portion outer, free end 18b both generally radially outwardly and generally axially away from the body base portion 16. However, the seal body 12 may have any appropriate shape that includes a generally cantilever-like section for sealing axially against a radially-extending surface.

Referring particularly to FIG. 5, in certain constructions, the seal assembly 10 further comprises a biasing member 30 disposed within the annular cavity C_{A} and configured to exert a generally radially-inwardly directed force on the seal body 12, as indicated by arrow F. The force F generated by the biasing member 30 substantially prevents relative angular displacement between the seal body 12 and the first member 1, provides a sealing pressure between the body inner surface 13 and the first member outer surface 1a. Preferably, the biasing member 30 is a garter spring, as depicted, but may alternatively be constructed as any other type of member or assembly capable of exerting a radially-inwardly directed force on the seal body 12.

With the above structure of the seal 12, each shield 14 is preferably formed so that the barrier surface 22 directs substances, for example dust, metallic particles, oil or other liquids, etc., into the seal cavity C_{A}, and thus away from the seal interface SI. Specifically, the shield body second axial end 20d is preferably spaced generally radially inwardly from the shield body first axial end 20c such that the barrier surface 22 is generally angled downwardly in a direction from the first end 20c toward the second end 20d. As such, substances contacting the barrier surface 22 are directed generally toward, so as to fall into, the seal member cavity C_{A}, and thereafter fall out of the cavity C_{A} when the particular cavity section passes beneath the axis A_{C} during rotation of the first member 1.

Referring to FIGS. 2 and 5, in an “angled” construction, the shield body 20 is formed as a generally rectangular plate 21 that is attached by the connectors 24 so as to be positioned in an angled orientation, as shown in FIG. 2. In another presently preferred construction, each shield body 20 is formed as a generally rectangular block 23 having a downwardly projecting shoulder 25 that “overhangs” an upper section of the sealing portion outer end 18b, as depicted in FIG. 5. With such a block 23, the shield barrier surface 22 is formed of a combination of both horizontal and vertical surface sections 27a, 27b, respectively. With either preferred construction, each shield body 20 preferably further includes a plurality of generally cylindrical cavities or pockets 29 each sized to receive a separate one of the preferred magnet connectors 26.

Although preferably formed as either the plate 21 or block 23, the body 20 of each shield 14 may be formed in any other appropriate manner to provide an angled barrier surface 22, such as a solid block with an angled surface, or even as a body 20 having a barrier surface 22 that is either generally horizontal or generally vertical (no alternatives shown). Further, each shield body 20 is preferably formed of an elastomeric material, such as rubber, but may alternatively be formed of a rigid polymeric material, a metallic material or any other appropriate material.

Referring now to FIGS. 3, 4 and 6, the seal assembly 10 preferably includes at least a first shield 15A and a second shield 15B spaced circumferentially from the first shield 15A. The first and second shields 15A, 15B are each disposed radially outwardly from a separate portion p₁, p₂, respectively, of the seal interface upper section u_{SI}. Each one of the first and second shields 15A, 15B has a body 20 with two opposing circumferential ends 20a, 20b, the first and second shields 15A, 15B being positioned such that one of the two ends (e.g., 20b) of the first shield 15A is disposed adjacent to a proximal one (i.e., 20a) of the two ends 20a, 20b of the second shield 15A. Particularly when there are only two shields 14, the adjacent ends 20b, 20a of the two shields 15A, 15B are preferably formed so as to substantially abut, as shown in FIGS. 3 and 4. In any case, the two shields 15A, 15B collectively provide a barrier for a substantially continuous upper section u_{SI} of the seal interface SI.

In certain applications, the seal assembly 10 includes three or more shields 15A, 15B, 15C, etc., each spaced radially outwardly from a separate portion p₁, p₂, p₃, etc. of the seal interface upper section u_{SI}, as depicted with three shields 14 in FIG. 5. In such constructions, the shields 14 are preferably arranged such the circumferential end 20a, 20b of one shield 14 is spaced radially from the proximal end 20b or 20a of the adjacent shield 14, so that there is an overlap of the adjacent ends 20b, 20a. However, the shields 15A, 15B, 15C may alternatively be formed in an abutting relationship similar to that depicted in FIGS. 3 and 4. Most preferably, for three shields 15A, 15B, 15C, the two circumferential ends 20a, 20b of the central shield 15B are each disposed radially outwardly from an adjacent end 20b, 20a of the first and third shields 15A, 15B, respectively. As such, the adjacent shields 14 collectively provide a substantially continuous barrier for the seal interface upper section u_{SI}.

By using two or more shields 14 for any seal assembly 10, the shields 14 may be constructed of generally uniform size and shape, such that only one or two shield designs need to be manufactured, and the exact number of shields 14 desired can be selected depending on the size of the seal body 12. In other words, when the seal body 12 has a relatively smaller outside diameter, two shields 14 of uniform size may collectively provide a sufficiently large barrier surface 22 to cover the entire seal interface upper section u_{SI}, as shown in FIGS. 3 and 4. When the seal body 12 has a relatively larger outside diameter, three or more shields 14 may be necessary to provide coverage for the entire upper section u_{SI} of the seal interface SI. Although preferably constructed having generally straight, generally rectangular bodies 20 of uniform size, the shields 14 may each be alternatively formed as an arcuate member and/or having a body with curvature to match the circumference of the outer end 18b of the seal body sealing portion 18, or/and may be utilized as only a single shield 14 of an appropriate shape for a particular seal assembly 10.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

I claim:

1. A seal assembly for sealing a space between first and second members, the first member having a central axis and an outer circumferential surface extending about the axis, the second member having a radially-extending axial surface, one of the first and second members being rotatable about the central axis, the seal assembly comprising:
a generally annular elastomeric seal body disposed about the first member outer surface and extending circumferentially about the central axis, the body including a base portion and a sealing portion, the sealing portion having an inner end integrally formed with the base portion and an outer, free end sealingly engageable with the second member axial surface so as to define a generally annular seal interface; and
at least one shield coupled with a non-rotatable one of the first and second members and spaced radially-outwardly from and located generally vertically above the seal interface so as to provide a barrier for preventing entry of substances into the seal interface.

2. The seal assembly as recited in claim 1 wherein the first member is the rotatable member and the at least one shield is mounted to the second member.

3. The seal assembly as recited in claim 2 wherein the at least one shield is attached to the second member axial surface.

4. The seal assembly as recited in claim 1 wherein the at least one shield includes a generally rectangular plate and at least one connector for coupling the plate to the non-rotatable one of the first and second members.

5. The seal assembly as recited in claim 4 wherein the second member is the non-rotatable member and the at least one connector includes a magnet for releasably attaching the shield to the second member axial surface.

6. The seal assembly as recited in claim 1 wherein the at least one shield includes a body having two opposing circumferential ends and a centerline extending between the circumferential ends, the body being positioned such that the centerline extends generally perpendicularly with respect to the central axis.

7. The seal assembly as recited in claim 6 wherein the shield body has two opposing axial ends and a barrier surface extending axially between the axial ends, one axial end being coupled with the non-rotatable one of the first and second members and the other axial end being located such that an upper section of the seal interface is generally covered by the barrier surface.

8. The seal assembly as recited in claim 1 wherein the at least one shield includes a first shield and a second shield spaced circumferentially from the first shield, the first and second shields each being disposed radially outwardly from a separate portion of the seal interface upper section.

9. The seal assembly as recited in claim 8 wherein each one of the first and second shields has a body with two opposing circumferential ends, the first and second shields being positioned such that one of the two ends of the first shield is disposed adjacent to a proximal one of the two ends of the second shield so as to a substantially continuous section of the seal interface.

10. The seal assembly as recited in claim 1 wherein the at least one shield has a body with two opposing axial ends and a barrier surface extending axially between the axial ends, one axial end being coupled with the non-rotatable one of the first and second members and the other axial end being located such that an upper section of the seal interface is generally covered by the barrier surface.

11. The seal assembly as recited in claim 10 wherein a generally annular cavity is defined between the seal body base portion and the seal body sealing portion, the annular cavity facing generally radially outwardly, the shield body first axial end is coupled with the second member and the shield body second axial end is spaced radially inwardly from the first end such that the barrier surface is generally angled downwardly from the first end toward the second end so that substances contacting the barrier surface are directed generally toward the seal member cavity.

12. The seal assembly as recited in claim 1 wherein the elastomeric seal body has generally V-shaped axial cross-sections and an inner circumferential surface sealingly engageable with the first member outer circumferential surface.

13. A seal assembly for sealing a space between first and second members, the first member having a central axis and an outer circumferential surface extending about the axis, the second member having a radially-extending axial surface, one of the first and second members being rotatable about the central axis, the seal assembly comprising:
a generally annular elastomeric seal body disposed about the first member outer surface and extending circumferentially about the central axis, the body including a base portion and a sealing portion, the sealing portion having an inner end integrally formed with the base portion and an outer, free end sealingly engageable with the second member axial surface so as to define a generally annular seal interface; and
at least one shield coupled with the second member and spaced radially-outwardly from and located generally vertically above the seal interface so as to provide a barrier for preventing entry of substances into the seal interface.

13. The seal assembly as recited in claim 13 wherein the at least one shield is attached to the second member axial surface.

14. The seal assembly as recited in claim 13 wherein the at least one shield includes a generally rectangular plate and at least one magnet for releasably attaching the plate to the second member axial surface.

15. The seal assembly as recited in claim 13 wherein the at least one shield includes a body having two opposing circumferential ends and a centerline extending between the circumferential ends, the body being positioned such that the centerline extends generally perpendicularly with respect to the central axis.

16. The seal assembly as recited in claim 13 wherein the at least one shield has a body with two opposing axial ends and a barrier surface extending axially between the axial ends, one axial end being coupled with the non-rotatable one of the first and second members and the other axial end being located such that an upper section of the seal interface is generally covered by the barrier surface.

17. The seal assembly as recited in claim 13 wherein the first axial end is coupled with the second member, the second axial end is spaced radially inwardly from the first end such that the barrier surface is generally angled downwardly from the first end toward the second end so that substances contacting the barrier surface are directed generally toward the seal cavity.

18. The seal assembly as recited in claim 13 wherein the at least one shield includes a first shield and a second shield spaced circumferentially from the first shield, the first and second shields each being disposed radially outwardly from a separate portion of the seal interface upper section.

19. The seal assembly as recited in claim 18 wherein each one of the first and second shields has a body with two opposing circumferential ends, the first and second shields being positioned such that one of the two ends of the first shield is disposed adjacent to a proximal one of the two ends of the second shield so as to provide a barrier for a substantially continuous section of the seal interface.

20. A seal assembly for sealing a space between first and second members, the first member having a central axis and an outer circumferential surface extending about the axis, the second member having a radially-extending axial surface, one of the first and second members being rotatable about the central axis, the seal assembly comprising:
a generally annular elastomeric seal body disposed about the first member outer surface and extending circumferentially about the central axis, the body including a base portion and a sealing portion, the sealing portion having an inner end integrally formed with the base portion and an outer, free end sealingly engageable with the second member axial surface so as to define a generally annular seal interface;
a first shield coupled with the second member and spaced radially-outwardly from and located generally vertically above a first portion of the seal interface so as to provide a barrier for preventing entry of substances into the seal interface first portion; and
a second shield coupled with the second member, spaced circumferentially about the axis from the first shield, and spaced radially-outwardly from and located generally vertically above a second portion of the seal interface so as to provide a barrier for preventing entry of substances into the seal interface second portion.
